(19) United States
(12) Patent Application Publication
(10) Pub. No.: US 2004/0101223 A1
(43) Pub. Date: May 27, 2004

(54) Wheel bearing assembly

(75) Inventors: Steven F. Baker, Bellevue, OH (US); Brian D. Turley, Milan, OH (US)

Correspondence Address: Scott A. McBain, Esq., Delphi Technologies Inc., Legal Staff, Mail Code 480-410-202, P.O. Box 5052, Troy, MI, 48007-5052, US

(73) Assignee: Delphi Technologies, Inc., Troy, MI

(21) Appl. No.: 10/304,241

(22) Filed: Nov. 26, 2002

(51) Int. Cl. F16C 13/00

(52) U.S. Cl. 384/544

(57) ABSTRACT

A wheel bearing assembly for a vehicle has a wheel hub with a spindle that extends axially from the hub. A rolling element bearing is coupled to the hub, over the spindle, and is secured to the spindle by a deformed end of the spindle. The deformed end engages a radially outward facing portion of a lip that extends from an inner ring of the rolling element bearing, such that no radially outward force is exerted on the inner ring by the deformed end.

### TECHNICAL FIELD

The present invention relates to vehicle suspensions, and more particularly to a wheel bearing assembly for securing a wheel to a vehicle.

### BACKGROUND OF THE INVENTION

Vehicle suspension systems include wheel bearing assemblies, which are used to mount wheels to a vehicle. Such wheel bearings are known in the art and generally comprise a wheel hub having a flange, to which a wheel may be attached by bolts, and a spindle that is used to couple the hub to the suspension components through a series of rolling elements. The rolling elements are commonly secured to the hub by cold forming an end of the spindle radially outward to capture an inner ring that forms a race for the rolling elements, as disclosed in U.S. Pat. No. 5,490,732, herein incorporated by reference in its entirety.

One drawback of securing the rolling elements to the spindle in this manner is that the cold forming operation tends to expand the inner ring radially outward, increasing hoop stresses in the ring which can lead to stress cracks and decreased durability of the wheel bearing. To address the outward expansion of the inner ring during cold forming, special jigs have been used to contain the ring during wheel bearing assembly, as described in U.S. Pat. No. 6,422,758, herein incorporated by reference in its entirety. The use and maintenance of such large jigs during manufacturing of wheel bearings is time consuming and increases the manufacturing costs of the wheel bearing assemblies. There is thus a need for a wheel bearing assembly that may be secured to the spindle of a wheel hub in a cost efficient manner that overcomes drawbacks of the prior art such as those described above.

### SUMMARY OF THE INVENTION

The present invention provides a wheel bearing assembly having a rolling element bearing secured to a spindle of the assembly in a manner which eliminates the hoop stress in the rolling bearing which is present in conventional assemblies due to the radially outward expansion of the rolling bearing.

In one aspect of the present invention, the rolling element bearing is coupled to a wheel hub of the wheel bearing assembly, over a spindle that extends along an axial direction of the hub. An inner ring of the rolling element bearing has a lip that extends in the axial direction and which includes a first surface that confronts the spindle and a second surface opposite the first surface and facing generally away from the spindle. The distal end of the spindle comprises a terminal portion that is configured to be formed over the lip such that it engages the second surface of the lip, thereby securing the rolling element bearing to the spindle. Because the formed end of the spindle does not exert an outward force on the inner ring, no hoop stress is developed in the inner ring. Advantageously, the end of the spindle may be formed to apply compressive axial and radial forces on the inner ring to preload the rolling bearing to improve the durability of the assembly.

In another aspect of the invention, a suspension module for a vehicle includes a wheel bearing assembly, as described above, coupled to a suspension knuckle and a suspension strut coupled to the suspension knuckle. The module may further include a brake caliper assembly.

In yet another aspect of the invention, a method of securing a rolling element bearing to a wheel hub includes mounting the bearing over the hub and deforming an end of a spindle on the hub over a portion of an inner ring of the bearing such that the deformed end covers a radially outward facing portion of the inner ring. These and other advantages, objectives and features of the present invention will become more readily apparent to those of ordinary skill upon review of the following detailed description of illustrative embodiments of the invention.

### BRIEF DESCRIPTION OF THE DRAWINGS

The present invention will now be described, by way of example, with reference to the accompanying drawings, in which:

FIG. 1 is a perspective view of a vehicle suspension module including a wheel bearing assembly according to the present invention; and

FIG. 2 is a partial cross-sectional view of an exemplary wheel bearing assembly of the present invention.

### DETAILED DESCRIPTION

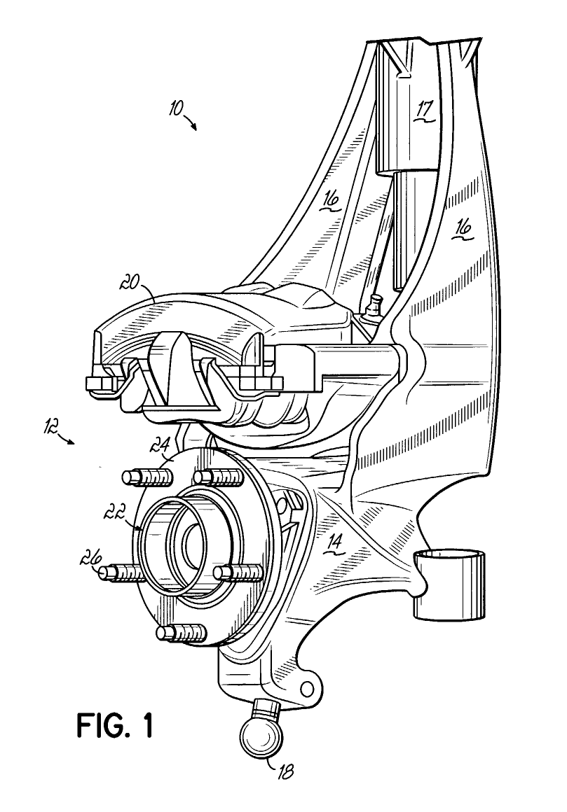

Referring to FIG. 1, there is shown a vehicle corner module 10 including an exemplary wheel bearing assembly 12 according to the present invention. The wheel bearing assembly 12 is mounted to a knuckle 14 having upwardly extending arms 16 which are couplable to the chassis of a vehicle and which support a suspension strut 17. The module 10 may further include a lower control arm ball joint 18 and a brake calliper assembly 20.

The wheel bearing assembly 12 includes a hub 22 having a first flange 24 that extends radially outward of the hub 22 and which supports a series of threaded studs 26 which have been press fit to the first flange 24 for securing a wheel thereto.

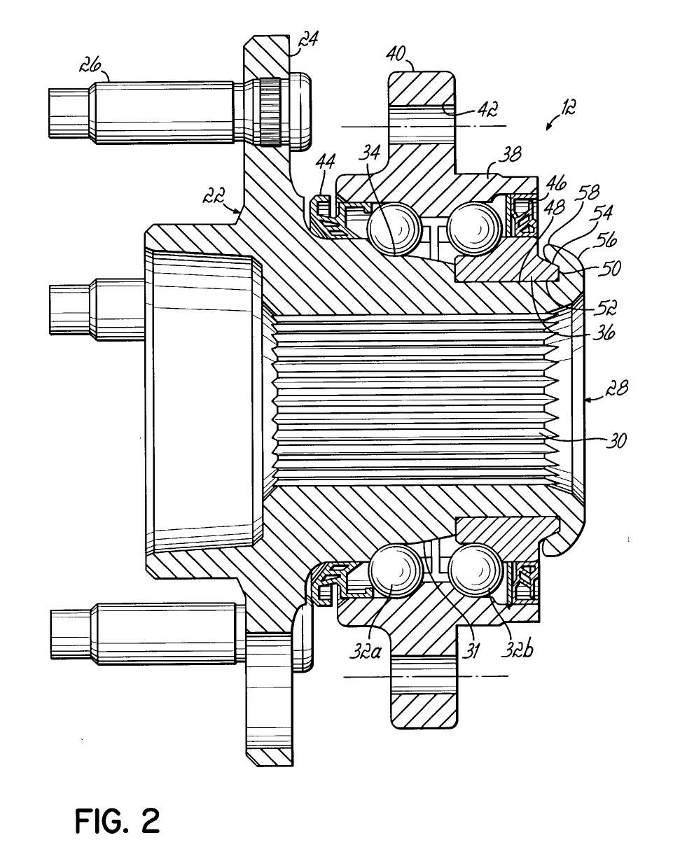

Referring now to FIG. 2, the hub 22 further includes a spindle portion 28 extending in an axial direction relative to the first flange 24. The spindle 28 may be solid or hollow in construction and the inner surface of a hollow spindle may be formed with a spline 30 which is configured to engage a driving axle of the vehicle.

The outer surface 31 of the spindle 28 is generally contoured to receive the rolling elements 32 of the bearing, either directly or contained within an inner ring member. In FIG. 2, a first series of rolling elements 32a is received directly in a groove 34 formed into the outer surface 31 of the spindle 28 and a second series of rolling elements 32b is supported between an inner ring 36 and an outer ring 38. The inner and outer rings 36, 38 are sized to be received onto the spindle 28. In the exemplary embodiment shown, the outer ring 38 includes a second flange 40 having a series of holes 42 which permit the wheel bearing assembly 12 to be bolted to the knuckle 14. Packing elements 44, 46 may be provided on opposite ends of the outer bearing ring 38 to seal the rolling elements 32 against contaminants.

In the exemplary embodiment shown, the inner ring 36 of the rolling element bearing is received in a recess 48 formed on the outer surface 31 of spindle 28 and has a lip 50 which extends in an axial direction adjacent to the spindle 28. The lip 50 includes a first surface 52, confronting spindle 28, and a second surface 54 spaced from the first surface. In the exemplary embodiment shown, the second surface 54 faces in a direction generally outward of the spindle 28. The spindle 28 has a terminal portion 56 that includes an annular collar 58 which is formed radially outward and over the lip 50 of the inner ring 36 to engage the second, outward facing surface 54 of the inner ring 36 and thereby secure the inner ring 36 to the spindle 28. The radially outward force of the spindle 28 against the inner surface of the inner ring, which typically develops in conventional wheel bearings during cold forming of the spindle 28, may be eliminated by sizing the inner ring 36 to have a slight clearance between the inner diameter of the ring 36 and the outer surface 31 of the spindle 28 when the ring 36 is placed on the spindle 28. In an exemplary embodiment, the terminal portion 56 of the spindle 28 may be configured such that it places the inner ring 36 in axial compression against the recess 48 formed into the spindle surface 31 when the annular collar 58 is formed over the lip 50 of the inner ring 36. As the annular collar 58 engages the second surface 54 of the inner ring 36, a radially compressive force is generated on the inner ring 36. Advantageously, the compressive axial and compressive radial forces of the flared end 56 of the spindle 28 on the inner ring 36 create compressive preload forces which improve the durability of the wheel bearing assembly 12.

While the present invention has been illustrated by the description of the various embodiments thereof, and while the embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicant's general inventive concept.

What is claimed is:

1. A wheel bearing assembly, comprising:
a wheel hub;
a spindle extending axially from said hub and having a terminal portion spaced from said hub;
a rolling element bearing coupled to said spindle and having at least one inner ring, said inner ring having first and second spaced surfaces with said first surface confronting said spindle; and
an annular collar of said terminal portion confronting said second surface to capture said inner ring.

2. The wheel bearing assembly of claim 1, wherein said first and second surfaces are parallel.

3. The wheel bearing assembly of claim 1, wherein said second surface is angled with respect to said first surface.

4. The wheel bearing assembly of claim 1, wherein said second surface is in contact with said annular collar.

5. The wheel bearing assembly of claim 1, further comprising a recess formed on said spindle and configured to receive said inner ring, whereby said inner ring is compressed within said recess by said annual collar.

6 The wheel bearing assembly of claim 1, wherein said inner ring further comprises a third surface, intermediate said first and second surfaces.

7. The wheel bearing assembly of claim 6, wherein said third surface is perpendicular to said first and second surfaces.

8. The wheel bearing assembly of claim 6, wherein said third surface is covered by said annular collar.

9. A method of securing a rolling element bearing to a wheel hub, the method comprising:
mounting a bearing over a spindle of the hub, the bearing including at least one inner ring;
deforming an end of the spindle to extend over a portion of the inner ring, whereby the deformed end covers a radially outward facing portion of the ring.

10. The method of claim 9, wherein the deformation of the end of the spindle compresses the ring in direction radially inward.

11. A suspension module for a vehicle, comprising:
a suspension knuckle;
a strut coupled to said knuckle; and
a wheel bearing assembly coupled to said knuckle, said wheel bearing comprising:
a wheel hub;
a spindle extending axially from said hub and having a terminal portion spaced from said hub;
a rolling element bearing coupled to said spindle and having at least one inner ring, said inner ring having first and second spaced surfaces with said first surface confronting said spindle; and
an annular collar of said terminal portion confronting said second surface to capture said inner ring.

12. The suspension module of claim 11, further comprising a brake caliper assembly.
